(19) United States
(12) Patent Application Publication
(10) Pub. No.: US 2025/0304821 A1
(43) Pub. Date: Oct. 2, 2025

(54) WATERBORNE ANTIFOULING COATING COMPOSITION

(71) Applicant: CHUGOKU MARINE PAINTS, LTD., Otake-shi (JP)

(72) Inventor: Kiwamu YAMANE, Otake-shi (JP)

(73) Assignee: CHUGOKU MARINE PAINTS, LTD., Otake-shi (JP)

(21) Appl. No.: 19/087,697

(22) Filed: Mar. 24, 2025

(30) Foreign Application Priority Data
Mar. 26, 2024 (JP) 2024-050082

(51) Int. Cl. C09D 193/04; C09D 5/16; C09D 133/04

(52) U.S. Cl. CPC C09D 193/04; C09D 5/1668; C09D 133/04

(57) ABSTRACT

A waterborne antifouling coating composition contains a synthetic resin (A), a rosin-based compound (B) having a weight average molecular weight of 800 or more, and water (C).

### CROSS-REFERENCE TO RELATED APPLICATION

The present application claims the priority from Japanese Patent Application No. 2024-050082 filed on Mar. 26, 2024, which is incorporated herein by reference in their entirety.

### BACKGROUND OF THE INVENTION

### Field of the Invention

The present disclosure relates to a waterborne antifouling coating composition and a method for producing the same, an antifouling coating film, a substrate with an antifouling coating film, and a method for producing a substrate with an antifouling coating film.

### Description of the Related Art

Conventionally, organic solvent dilution type compositions have been used as antifouling coating compositions. In recent years, from the viewpoint of environmental conservation or improvement of a coating work environment, there has been a demand for waterborne conversion of antifouling coating compositions, that is, waterborne antifouling coating compositions (for example, refer to JP S51-014936 A, JP 2009-173914 A, JP 2003-277680 A, and WO 2023/232825 A).

### SUMMARY OF THE INVENTION

Waterborne conversion of the antifouling coating composition is effective for reducing the amount of volatile organic compounds (VOC). However, an antifouling coating film formed from the waterborne antifouling coating composition has high affinity with water. Therefore, it has been difficult for such an antifouling coating film to exhibit antifouling properties over a long period of time.

In view of such a problem, the present inventors have found that an antifouling coating film containing a rosin-based compound tends to be excellent in antifouling properties over a long period of time. However, as a result of further studies, the present inventors have found that the storage stability of a waterborne antifouling coating composition containing a rosin-based compound may not be sufficient. One object of the present disclosure is to provide a waterborne antifouling coating composition excellent in storage stability.

According to an aspect of the present disclosure, there is provided a waterborne antifouling coating composition containing a synthetic resin (A), a rosin-based compound (B) having a weight average molecular weight of 800 or more, and water (C).

According to the present disclosure, it is possible to provide a waterborne antifouling coating composition excellent in storage stability.

### DESCRIPTION OF EMBODIMENTS

Hereinafter, an embodiment of the present disclosure will be described in detail.

One or more of each component described in the present specification can be used.

In the present specification, a homopolymer and a copolymer may be described as a “polymer” without being particularly distinguished. That is, the term “polymer” is used to mean a homopolymer or a copolymer.

The term “(meth)acrylate” is used to mean either acrylate or methacrylate. The term “(meth)acrylic” is used to mean either acrylic or methacrylic. The term “(meth)acrylic acid” is used to mean either acrylic acid or methacrylic acid.

In the present specification, the numerical range n1 to n2 means a numerical range of n1 or more and n2 or less when n1<n2, and means a numerical range of n2 or more and n1 or less when n1>n2. In the present disclosure, when a plurality of lower limit values and a plurality of upper limit values are described for a certain element, a numerical range obtained by combining a value optionally selected from the described lower limit values and a value optionally selected from the described upper limit values is also assumed to be described.

The term “structural unit derived from monomer X” is, for example, a structural unit represented by the following Formula where monomer X is represented by A¹A²C═CA³A⁴ (C═C is a polymerizable carbon-carbon double bond, and A¹ to A⁴ are each an atom or a group bonded to a carbon atom).

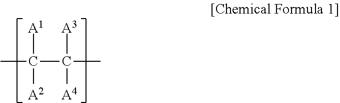

### [Waterborne Antifouling Coating Composition (Composition (I))]

The waterborne antifouling coating composition (hereinafter also referred to as “composition (I)”) of the present disclosure contains a synthetic resin (A), a rosin-based compound (B), and water (C), each of which will be described below.

### <Synthetic Resin (A)>

Examples of the synthetic resin (A) include a (meth)acrylic resin, a styrene-based resin, and a urethane-based resin. Among them, (meth)acrylic resins and styrene-based resins are preferable from the viewpoint that, for example, an antifouling coating film excellent in crack resistance in an outdoor exposure test, crack resistance in water immersion, and antifouling properties over a long period of time can be easily formed, and (meth)acrylic resins are more preferable from the viewpoint that, for example, an antifouling coating film more excellent in crack resistance can be easily formed, and such a synthetic resin (A) can be easily obtained.

The (meth)acrylic resin includes a structural unit derived from a (meth)acrylic monomer, and may further include a structural unit derived from an ethylenically unsaturated monomer (hereinafter also referred to as an “additional ethylenically unsaturated monomer”) copolymerizable with the (meth)acrylic monomer. The (meth)acrylic resin may be a homopolymer of a (meth)acrylic monomer, a copolymer of two or more kinds of (meth)acrylic monomers, or a copolymer of a (meth)acrylic monomer and an additional ethylenically unsaturated monomer. The copolymer may be, for example, a random copolymer or a block copolymer. The (meth)acrylic resin may include two or more kinds of structural units derived from (meth)acrylic monomers. The (meth)acrylic resin may include one kind or two or more kinds of structural units derived from additional ethylenically unsaturated monomers.

Examples of the (meth)acrylic monomer include (meth)acrylic acid ester, (meth)acrylic acid amide, (meth)acrylonitrile, and (meth)acrylic acid.

Examples of the (meth)acrylic acid ester include: alkyl (meth)acrylates such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-hexyl (meth)acrylate, 2-ethylhexyl (meth)acrylate, and lauryl (meth)acrylate; cycloalkyl (meth)acrylates such as cyclohexyl (meth)acrylate; aryl (meth)acrylates such as phenyl (meth)acrylate; aralkyl (meth)acrylates such as benzyl (meth)acrylate; hydroxyalkyl (meth)acrylates such as 2-hydroxyethyl (meth)acrylate, 2-hydroxypropyl (meth)acrylate, 3-hydroxypropyl (meth)acrylate, and 4-hydroxybutyl (meth)acrylate; alkoxyalkyl (meth)acrylates such as methoxybutyl (meth)acrylate, methoxyethyl (meth)acrylate, and ethoxybutyl (meth)acrylate; epoxy group-containing (meth)acrylates such as glycidyl (meth)acrylate; and aminoalkyl (meth)acrylates such as aminoethyl (meth)acrylate, dimethylaminoethyl (meth)acrylate, and butylaminoethyl (meth)acrylate.

Examples of the (meth)acrylic acid amide include: (meth)acrylic acid aminoalkylamides such as aminoethyl (meth)acrylamide, dimethylaminomethyl (meth)acrylamide, and methylaminopropyl (meth)acrylamide; and other amide group-containing (meth)acrylic monomers such as (meth)acrylamide, N,N-dimethyl(meth)acrylamide, N,N-diethyl(meth)acrylamide, N-methylol(meth)acrylamide, methoxybutyl(meth)acrylamide, and diacetone(meth)acrylamide.

Examples of the additional ethylenically unsaturated monomer include: α-olefins such as ethylene, propylene, and 1-butene; conjugated dienes such as 1,3-butadiene, isoprene, and chloroprene; styrene-based monomers such as styrene, α-methylstyrene, vinyltoluene, and halogenated styrene; vinyl esters such as vinyl acetate and vinyl propionate; unsaturated monocarboxylic acids such as crotonic acid; unsaturated dicarboxylic acids such as maleic acid, fumaric acid, and itaconic acid; monoesters of unsaturated dicarboxylic acids such as ethyl maleate and butyl maleate; and diesters of unsaturated dicarboxylic acids such as diethyl maleate and dibutyl maleate.

In the (meth)acrylic resin, the content ratio of the structural unit derived from the (meth)acrylic monomer based on 100% by mass of the total amount of the structural units derived from a polymerizable monomer is preferably 20% by mass or more, more preferably 30% by mass or more, still more preferably 40% by mass or more, further preferably 50% by mass or more, and particularly preferably 60% by mass or more. In the present specification, the content ratio of each structural unit is measured by nuclear magnetic resonance spectroscopy (NMR).

In the (meth)acrylic resin, the content ratio of the structural unit derived from the additional ethylenically unsaturated monomer based on 100% by mass of the total amount of structural units derived from a polymerizable monomer is preferably 80% by mass or less, more preferably 70% by mass or less, still more preferably 60% by mass or less, further preferably 50% by mass or less, and particularly preferably 40% by mass or less.

Examples of the (meth)acrylic resin include a polymer of a (meth)acrylic monomer, which is a homopolymer or a copolymer of the (meth)acrylic monomer, a copolymer of a (meth)acrylic monomer and a styrene-based monomer, and a copolymer of a (meth)acrylic monomer and a vinyl ester. The (meth)acrylic resin may be, for example, a urethane-modified product or a silicone-modified product.

The (meth)acrylic resin may be a self-crosslinking type or a non-self-crosslinking type.

The glass transition temperature (Tg) of the (meth)acrylic resin is preferably −50° C. or higher, more preferably −30° C. or higher, still more preferably −10° C. or higher, and particularly preferably 0° C. or higher, and is preferably 90° C. or lower, more preferably 70° C. or lower, still more preferably 60° C. or lower, and particularly preferably 50° C. or lower, for example, −50 to 90° C., from the viewpoint that, for example, an antifouling coating film excellent in balance between crack resistance and antifouling properties can be easily formed. The Tg of the (meth)acrylic resin is a temperature (° C.) at an onset value of DSC during heating, the temperature (° C.) being obtained by measuring a heat quantity change in a range of −50° C. to 150° C. at a temperature rising rate of 20° C./min in a nitrogen atmosphere using a differential scanning calorimetry (DSC) apparatus.

The (meth)acrylic resin may have an acid value of more than 0 mgKOH/g. The acid value of the (meth)acrylic resin is preferably 1 mgKOH/g or more, more preferably 5 mgKOH/g or more, and still more preferably 10 mgKOH/g or more, and is preferably 35 mgKOH/g or less, more preferably 30 mgKOH/g or less, and still more preferably 25 mgKOH/g or less, for example, 1 to 35 mgKOH/g. The (meth)acrylic resin having an acid value of the lower limit value or more tends to be excellent in stability in the waterborne antifouling coating composition. A composition containing a (meth)acrylic resin having an acid value of the upper limit value or less tends to be able to form a coating film excellent in water resistance. The acid value of the (meth)acrylic resin is the amount (mg) of potassium hydroxide necessary for neutralizing an acid group such as a carboxy group per 1 g of the solid content of the sample, and is measured in accordance with JIS K0070:1992 (neutralization titration method).

Examples of the method for synthesizing the (meth)acrylic resin include known methods, and examples thereof include a method in which a polymerizable monomer is polymerized by a solution polymerization method, a suspension polymerization method, a bulk polymerization method, or an emulsion polymerization method in the presence of a radical polymerization initiator.

The (meth)acrylic resin is produced by a known method such as a solution radical polymerization method by appropriately selecting the (meth)acrylic monomer and the additional ethylenically unsaturated monomer as necessary in consideration of a structural unit, a weight average molecular weight, and the like.

Examples of the styrene-based resin include a homopolymer or a copolymer of a styrene-based monomer, and a copolymer of a styrene-based monomer and a monomer copolymerizable therewith. Examples of the styrene-based monomer include styrene, α-methylstyrene, vinyltoluene, and halogenated styrene, and among these, styrene is preferable. Examples of the monomer copolymerizable with the styrene-based monomer include the above-mentioned additional ethylenically unsaturated monomers (here, the styrene-based monomer is excluded). The styrene-based resin may be, for example, a urethane-modified product or a silicone-modified product.

In the present specification, the (meth)acrylic resin is excluded from the styrene-based resin. That is, a resin including a structural unit derived from a (meth)acrylic monomer and a structural unit derived from a styrene-based monomer is classified as the (meth)acrylic resin.

The urethane-based resin may be a reaction product of a polyol compound and a polyisocyanate compound. Examples of polyol compounds include polyhydric alcohols, polyether polyols, polyester polyols, polyether ester polyols, (meth)acrylic polyols, polycarbonate polyols, and polyolefin polyols. Examples of the polyisocyanate compound include aliphatic polyisocyanates, alicyclic polyisocyanates, and aromatic polyisocyanates.

The weight average molecular weight (Mw) of the synthetic resin (A) is preferably 1,000 or more and more preferably 2,000 or more, and is preferably 1,000,000 or less and more preferably 700,000 or less, from the viewpoint of obtaining an antifouling coating composition excellent in film formability, and the like. The Mw is measured by gel permeation chromatography (GPC method). When the synthetic resin (A) is a so-called self-crosslinking type resin that increases in molecular weight upon evaporation of water, the above Mw is not limited to the upper limit value.

The synthetic resin (A) is preferably water-dispersible particles that can be dispersed in water. When the synthetic resin (A) is (meth)acrylic resin particles, the (meth)acrylic resin constituting the particles may have, for example, a hydrophilic group such as a carboxy group or a hydroxy group.

The synthetic resin (A) may be present in the form of particles in the composition (I). For example, during the coating and drying of the composition (I), water evaporates and the particles are bound to each other to form a film. The Z-average particle diameter of the synthetic resin (A) is preferably 10 nm or more, more preferably 20 nm or more, still more preferably 30 nm or more, and particularly preferably 50 nm or more, and is preferably 2 μm or less, more preferably 1 μm or less, still more preferably 500 nm or less, and particularly preferably 300 nm or less, for example, 10 nm to 2 μm. The synthetic resin (A) having a Z-average particle diameter within the above range tends to be able to be stably present in the waterborne antifouling coating composition, and such a composition tends to be able to form a coating film having uniform coating film properties. In the present specification, the Z-average particle diameter is measured at 23° C. by a dynamic light scattering method (DLS) using a particle diameter measuring apparatus (for example, Zetasizer Nano-ZS manufactured by Malvern Panalytical).

The composition (I) may contain two or more kinds of the synthetic resins (A).

The content ratio of the synthetic resin (A) is preferably 3% by mass or more, more preferably 5% by mass or more, and still more preferably 78 by mass or more, and is preferably 30% by mass or less, more preferably 25% by mass or less, still more preferably 20% by mass or less, and particularly preferably 16% by mass or less, for example, 3 to 30% by mass, based on 100% by mass of the solid content of the composition (I).

The content ratio of the solid content in the composition (I) is preferably 40% by mass or more, more preferably 45% by mass or more, and still more preferably 50% by mass or more, and is preferably 80% by mass or less, more preferably 75% by mass or less, and still more preferably 70% by mass or less, for example, 40 to 80% by mass, from the viewpoint that a composition excellent in coating workability can be obtained.

The solid content of the composition (I) and each component (for example, waterborne dispersion) means a heating residue when the composition (I) and each component are respectively dried in a thermostatic chamber at 108° C. for 3 hours. The content ratio of the solid content is measured by the method described in the Example section.

In the production of the composition (I), from the viewpoint of coating film properties, it is preferable to use a waterborne dispersion of the synthetic resin (A), and it is more preferable to use a waterborne emulsion of the synthetic resin (A). As a result, the synthetic resin (A) tends to be stably and uniformly present in the composition (I), and a coating film having uniform coating film properties tends to be formed.

The waterborne emulsion of the synthetic resin (A) may be prepared, for example, by emulsifying the synthetic resin (A) using a surfactant, or may be directly prepared by emulsion polymerization of a polymerizable monomer forming the synthetic resin (A). The surfactant is not particularly limited, and can be appropriately selected from a cationic surfactant, an anionic surfactant, and a nonionic surfactant.

The content ratio of the synthetic resin (A) in the waterborne dispersion is preferably 20% by mass or more, more preferably 30% by mass or more, and still more preferably 40% by mass or more, and is preferably 80% by mass or less, more preferably 75% by mass or less, and still more preferably 70% by mass or less, for example, 20 to 80% by mass, from the viewpoint of stability of the dispersion, workability in production of a coating material, and the like.

The waterborne dispersion of the synthetic resin (A) is a dispersion in which the synthetic resin (A) is dispersed in a dispersion medium (hereinafter also referred to as a “waterborne medium”) containing water. The waterborne medium is not particularly limited as long as the waterborne medium contains water. The content ratio of water in the waterborne medium is preferably 50% by mass or more, more preferably 60% by mass or more, still more preferably 70% by mass or more, further preferably 80% by mass or more, and particularly preferably 90% by mass or more, from the viewpoint of reducing the environmental load.

The waterborne medium may contain a medium other than water. Examples of such a medium include acetone, methyl alcohol, ethyl alcohol, n-propyl alcohol, isopropyl alcohol, n-butyl alcohol, isobutyl alcohol, 2-methoxyethanol, 2-ethoxyethanol, 2-butoxyethanol, 1-methoxy-2 propanol, 1-ethoxy-2 propanol, diacetone alcohol, dioxane, ethylene glycol, ethylene glycol dimethyl ether, ethylene glycol diethyl ether, ethylene glycol monopropyl ether, and ethylene glycol monohexyl ether. The above medium may be one kind or two or more kinds.

The pH of the waterborne dispersion of the synthetic resin (A) at 23° C. is preferably 7.0 to 12.0, more preferably 7.0 to 10.0, and still more preferably 7.0 to 9.0, from the viewpoint of the stability of the waterborne dispersion and the like. By using such a waterborne dispersion, for example, the synthetic resin (A) is likely to be stably and uniformly present in the composition (I). Therefore, a coating film having uniform coating film properties can be formed using the composition (I).

### <Rosin-Based Compound (B)>

The rosin-based compound (B) is at least one selected from rosin which is an unmodified rosin and a derivative of rosin. The composition (I) containing the rosin-based compound (B) in addition to the synthetic resin (A) can form an antifouling coating film excellent in antifouling properties.

Examples of the rosin include natural rosin, and specifically include gum rosin, tall oil rosin, and wood rosin. Examples of the component constituting the rosin include abietic acid, neoabietic acid, dehydroabietic acid, secodehydroabietic acid, dihydroabietic acid, tetrahydroabietic acid, pimaric acid, isopimaric acid, levopimaric acid, palustric acid, and sandaracopimaric acid. The above component constituting the rosin may be one kind or two or more kinds.

Examples of derivatives of rosin include rosin-based esters, hydrogenated rosins, disproportionated rosins, polymerized rosins (also referred to as dimerized rosin), acid-modified rosins, and rosin-modified phenolic resins. Among them, rosin-based esters, hydrogenated rosins, disproportionated rosins, polymerized rosins, and acid-modified rosins are preferable, and rosin-based esters are more preferable, from the viewpoint that, for example, a waterborne antifouling coating composition excellent in storage stability can be prepared, and an antifouling coating film excellent in antifouling properties can be formed. Examples of the acid-modified rosin include maleic acid-modified rosin, maleic anhydride-modified rosin, fumaric acid-modified rosin, and (meth)acrylic acid-modified rosin. The derivative of rosin may be one kind or two or more kinds.

Rosin and derivatives of rosin may take the form of salts. Examples of these salts include ammonium salts and metal salts (saponified rosin and saponified rosin derivatives). Examples of the above metal salt include alkali metal salts such as a sodium salt and a potassium salt, zinc salts, copper salts, aluminum salts, magnesium salts, calcium salts, and barium salts.

The weight average molecular weight (Mw) of the rosin-based compound (B) is 800 or more. Although the reason is not clear, by using such a rosin-based compound having such an Mw, for example, a waterborne antifouling coating composition having more excellent storage stability can be prepared as compared with the case of using a rosin-based compound having a small Mw.

The weight average molecular weight (Mw) of the rosin-based compound (B) is preferably 850 or more, more preferably 900 or more, still more preferably 950 or more, and particularly preferably 1,000 or more. The weight average molecular weight (Mw) of the rosin-based compound (B) is preferably 3,000 or less, more preferably 2,750 or less, still more preferably 2,500 or less, further preferably 2,250 or less, and particularly preferably 2,000 or less. The above Mw is, for example, preferably 800 to 3,000, more preferably 850 to 2,750, still more preferably 900 to 2,500, further preferably 950 to 2, 250, and particularly preferably 1,000 to 2,000.

The weight average molecular weight (Mw) of the rosin-based compound (B) is a value in terms of standard polystyrene measured by a gel permeation chromatography method (GPC method). Details of the measurement conditions are described in the Example section.

The rosin-based compound (B) preferably contains a rosin-based ester, and more preferably contains a rosin-based ester as a main component. Examples of the rosin-based ester include an ester of a rosin and an alcohol, and an ester of a derivative of rosin (esters are excluded) and an alcohol. Although the reason is not clear, by using a rosin-based ester, for example, a waterborne antifouling coating composition having more excellent storage stability can be prepared as compared with the case of using rosin (free rosin acid) as a free acid, acid-modified rosin, or a salt of rosin.

As the alcohol, a polyhydric alcohol is preferable. The polyhydric alcohol is a compound having 2 or more, preferably 2 to 10, more preferably 2 to 8, still more preferably 3 to 6, and particularly preferably 3 to 4 alcoholic hydroxyl groups. In one embodiment, the polyhydric alcohol is a trihydric or higher polyhydric alcohol having three or more alcoholic hydroxyl groups.

Examples of the polyhydric alcohol include:
an aliphatic diol having preferably 20 or less carbon atoms, more preferably 10 or less carbon atoms, and still more preferably 6 or less carbon atoms, such as ethylene glycol, diethylene glycol, triethylene glycol, 1,2-propanediol, 1,3-propanediol, dipropylene glycol, 1,3-butanediol, 1,4-butanediol, neopentyl glycol, 1,5-pentanediol, 1,6-hexanediol, 1,8-octanediol, 1,10-decanediol, and 1,4-cyclohexanedimethanol; and
a trihydric or higher aliphatic alcohol having preferably 20 or less carbon atoms, more preferably 10 or less carbon atoms, and still more preferably 6 or less carbon atoms, such as glycerin, diglycerin, trimethylolethane, trimethylolpropane, butanetriol, pentanetriol, hexanetriol, pentaerythritol, dipentaerythritol, glucose, sucrose, and sorbitol.

Among the alcohols, a polyhydric alcohol is preferable, a trihydric or higher polyhydric alcohol is more preferable, a trihydric or higher aliphatic alcohol is still more preferable, and glycerin or pentaerythritol is particularly preferable. That is, the rosin-based ester is preferably an ester of rosin or a derivative thereof and a polyhydric alcohol, more preferably an ester of rosin or a derivative thereof and a trihydric or higher polyhydric alcohol, still more preferably an ester of rosin or a derivative thereof and a trihydric or higher aliphatic alcohol, and particularly preferably an ester of rosin or a derivative thereof and glycerin, or an ester of rosin or a derivative thereof and pentaerythritol.

Specific examples of the rosin-based ester include rosin esters, hydrogenated rosin esters, disproportionated rosin esters, polymerized rosin esters, acid-modified rosin esters, and rosin ester-modified phenol resins. Among these, rosin esters, hydrogenated rosin esters, disproportionated rosin esters, polymerized rosin esters, and acid-modified rosin esters are preferable.

In one embodiment, the rosin-based compound (B) may further contain at least one component selected from rosin, an ammonium salt of rosin, and a rosin metal salt (saponified rosin) together with the rosin-based ester. Examples of the rosin metal salt include alkali metal salts such as a sodium salt and a potassium salt, zinc salts, copper salts, aluminum salts, magnesium salts, calcium salts, and barium salts.

The rosin-based compound (B) preferably contains the rosin-based ester as a main component, that is, in a range of more than 50% by mass. The content ratio of the rosin-based ester in the rosin-based compound (B) is preferably more than 50% by mass, and may be, for example, 60% by mass or more, 70% by mass or more, 80% by mass or more, or 90% by mass or more. The composition (I) containing the rosin-based compound (B) of such an aspect is excellent in storage stability.

The glass transition temperature (Tg) of the rosin-based compound (B) is preferably 0° C. or higher, more preferably 10° C. or higher, still more preferably 15° C. or higher, and particularly preferably 20° C. or higher, and is preferably 80° C. or lower, more preferably 60° C. or lower, still more preferably 55° C. or lower, further preferably 50° C. or lower, even more preferably 45° C. or lower, and particularly preferably 40° C. or lower, for example, 0 to 80° C., from the viewpoint of coating workability, storage stability, and the like. The Tg of the rosin-based compound (B) is measured using a differential scanning calorimetry (DSC) apparatus. Details of the measurement conditions are described in the Example section.

The acid value of the rosin-based compound (B) is preferably 100 mgKOH/g or less, more preferably 80 mgKOH/g or less, still more preferably 70 mgKOH/g or less, further preferably 60 mgKOH/g or less, and particularly preferably 50 mgKOH/g or less, and may be, for example, 40 mgKOH/g or less, 35 mgKOH/g or less, 30 mgKOH/g or less, 25 mgKOH/g or less, 20 mgKOH/g or less, or 15 mgKOH/g or less. The composition (I) containing the rosin-based compound (B) having an acid value of the above upper limit value or less is more excellent in storage stability.

The lower limit value of the acid value of the rosin-based compound (B) is not particularly limited. The acid value of the rosin-based compound (B) may be, for example, 0 mgKOH/g or more, 5 mgKOH/g or more, or 10 mgKOH/g or more.

The acid value of the rosin-based compound (B) is the amount (mg) of potassium hydroxide necessary for neutralizing an acid group such as a carboxy group per 1 g of the solid content of the sample, and is measured in accordance with JIS K0070:1992 (neutralization titration method).

The rosin-based compound (B) is preferably water-dispersible particles that can be dispersed in water. The rosin-based compound (B) may be present in the form of particles in the composition. The Z-average particle diameter of the rosin-based compound (B) is preferably 10 nm or more, more preferably 20 nm or more, still more preferably 30 nm or more, and particularly preferably 50 nm or more, and is preferably 2 μm or less, more preferably 1 μm or less, still more preferably 500 nm or less, and particularly preferably 300 nm or less, for example, 10 nm to 2 μm. The rosin-based compound (B) having a Z-average particle diameter within the above range tends to be able to be stably present in the waterborne antifouling coating composition, and such a composition tends to be able to form a coating film having uniform coating film properties.

The composition (I) may contain two or more kinds of the rosin-based compounds (B).

In the composition (I), the content ratio of the synthetic resin (A) and the rosin-based compound (B) (content of (A):content of (B)) is, for example, 1.0:0.3 to 1.0:4.0, preferably 1.0:0.7 to 1.0:3.0, more preferably 1.0:0.9 to 1.0:2.8, still more preferably 1.0:1.2 to 1.0:2.5, further preferably 1.0:1.4 to 1.0:2.4, and particularly preferably 1.0:1.5 to 1.0:2.3 on a mass basis. The composition (I) containing the synthetic resin (A) and the rosin-based compound (B) at the content ratio described above can form an antifouling coating film excellent in balance between crack resistance in an outdoor exposure test and antifouling properties over a long period of time. When the ratio of the content of the rosin-based compound (B) to the synthetic resin (A) is large, the antifouling properties tend to be more excellent, and when the ratio of the content of the rosin-based compound (B) to the synthetic resin (A) is small, the crack resistance tends to be more excellent.

The content ratio of the rosin-based compound (B) is preferably 3% by mass or more, more preferably 5% by mass or more, and still more preferably 10% by mass or more, and is preferably 40% by mass or less, more preferably 35% by mass or less, still more preferably 30% by mass or less, and particularly preferably 25% by mass or less, for example, 3 to 40% by mass, based on 100% by mass of the solid content of the composition (I). The composition (I) of such an aspect can form an antifouling coating film excellent in balance between crack resistance in an outdoor exposure test and antifouling properties over a long period of time.

In the production of the composition (I), from the viewpoint of coating film properties, it is preferable to use a waterborne dispersion of the rosin-based compound (B), and it is more preferable to use a waterborne emulsion of the rosin-based compound (B). As a result, the rosin-based compound (B) tends to be stably and uniformly present in the composition (I), and a coating film having uniform coating film properties tends to be formed.

The content ratio of the rosin-based compound (B) in the waterborne dispersion is preferably 20% by mass or more, more preferably 30% by mass or more, and still more preferably 40% by mass or more, and is preferably 80% by mass or less, more preferably 75% by mass or less, and still more preferably 70% by mass or less, for example, 20 to 80% by mass, from the viewpoint of stability of the dispersion, workability in production of a coating material, and the like.

The waterborne dispersion of the rosin-based compound (B) is a dispersion in which the rosin-based compound (B) is dispersed in a waterborne medium. The waterborne medium is not particularly limited as long as the waterborne medium contains water. The content ratio of water in the waterborne medium is preferably 50% by mass or more, more preferably 60% by mass or more, still more preferably 70% by mass or more, further preferably 80% by mass or more, and particularly preferably 90% by mass or more, from the viewpoint of reducing the environmental load. Specific examples of the medium other than water in the waterborne medium are as described above.

The pH of the waterborne dispersion of the rosin-based compound (B) at 23° C. is preferably 6.0 to 12.0, more preferably 6.0 to 10.0, still more preferably 6.0 to 9.0, and particularly preferably 6.0 to 8.5, from the viewpoint of the stability of the waterborne dispersion of the rosin-based compound (B), the stability of the synthetic resin (A) in the composition (I), and the like.

### <Water (C)>

The composition (I) is a waterborne antifouling coating composition. The “waterborne” composition refers to a composition containing water. Examples of the water (C) include tap water, ion-exchanged water, and deionized water, and ion-exchanged water or deionized water is preferable. Examples of the water (C) include water contained in the waterborne dispersion of the synthetic resin (A) and water contained in the waterborne dispersion of the rosin-based compound (B).

The content ratio of the water (C) in the composition (I) is preferably 20% by mass or more, more preferably 25% by mass or more, and still more preferably 30% by mass or more, and is preferably 60% by mass or less, more preferably 55% by mass or less, and still more preferably 50% by mass or less, for example, 20 to 60% by mass. The content ratio of the water (C) is measured using a moisture measuring apparatus (for example, CA-310 manufactured by Nittoseiko Analytech Co., Ltd.) according to the Karl Fischer method.

### <Antifouling Agent (D)>

The composition (I) may further contain an antifouling agent (D).

Examples of the antifouling agent (D) include inorganic antifouling agents and organic antifouling agents.

Examples of the inorganic antifouling agent include copper and copper compounds (here, pyrithione compounds are excluded) such as cuprous oxide, metal copper powder, and copper (I) thiocyanate (copper rhodanide). Among them, cuprous oxide or copper (I) thiocyanate (copper rhodanide) is preferable.

Examples of the organic antifouling agent include:
metal pyrithiones (pyrithione-based compounds) such as copper pyrithione and zinc pyrithione;
tetraalkylthiuram disulfides such as tetramethylthiuram disulfide;
carbamate-based compounds such as zinc dimethyl dithiocarbamate, zinc ethylene bisdithiocarbamate, and bis dimethyldithiocarbamoyl zinc ethylene bisdithiocarbamate;
maleimide-based compounds such as 2,4,6-triphenylmaleimide, 2,3-dichloro-N-(2′,6′-diethylphenyl) maleimide, and 2,3-dichloro-N-(2′-ethyl-6′-methylphenyl) maleimide;
2,4,5,6-tetrachloroisophthalonitrile, N,N-dimethyldichlorophenylurea, 4,5-dichloro-2-n-octyl-4-isothiazoline-3-one, 2-methylthio-4-tert-butylamino-6-cyclopropyl-S-triazine, chloromethyl-n-octyl disulfide, N′,N′-dimethyl-N-phenyl-(N-fluorodichloromethylthio) sulfamide, and N′,N′-dimethyl-N-tolyl-(N-fluorodichloromethylthio) sulfamide;
amine-organic borane complexes such as pyridine triphenylborane and 4-isopropylpyridine diphenylmethylborane; and
(+/−)-4-[1-(2,3-dimethylphenyl)ethyl]-1H-imidazole (hereinafter referred to as “medetomidine”).

Among the organic antifouling agents, copper pyrithione, zinc pyrithione, zinc ethylene bisdithiocarbamate, 2-methylthio-4-tert-butylamino-6-cyclopropyl-S-triazine or medetomidine is preferable, and copper pyrithione, zinc ethylene bisdithiocarbamate, or medetomidine is more preferable.

The composition (I) may contain one or more kinds of antifouling agents (D).

The content ratio of the antifouling agent (D) when the composition (I) contains the antifouling agent (D) is preferably 0.01% by mass or more, more preferably 0.1% by mass or more, still more preferably 18 by mass or more, further preferably 5% by mass or more, and particularly preferably 10% by mass or more, and is preferably 80% by mass or less and more preferably 70% by mass or less, for example, 0.01 to 80% by mass, based on 100% by mass of the solid content of the composition (I).

### Other Components

The composition (I) may further contain components (hereinafter also referred to as “other components”) other than the components described above, such as pigments and additives. Examples of the additives include dispersants, defoamers, viscosity adjusting agents, coalescents, antifungal agents, antiseptic agents, pH adjusting agents, ultraviolet absorbing agents, and antioxidants.

The composition (I) may contain one or more kinds of other components.

Examples of the pigment include extender pigments and coloring pigments. Examples of the pigment include organic pigments and inorganic pigments. The composition (I) may contain one or more kinds of pigments.

Examples of the extender pigment include talc, silica, mica, clay, potassium feldspar, calcium carbonate, kaolin, alumina white, white carbon, aluminum hydroxide, magnesium carbonate, barium carbonate, barium sulfate, zinc oxide, and zinc sulfide.

When the composition (I) contains the extender pigment, the content ratio of the extender pigment is preferably 0.1% by mass or more, more preferably 18 by mass or more, and still more preferably 5% by mass or more, and is preferably 80% by mass or less, more preferably 70% by mass or less, and still more preferably 60% by mass or less, for example, 0.1 to 80% by mass, based on 100% by mass of the solid content of the composition (I).

Examples of the coloring pigment include organic pigments and inorganic pigments. Examples of the organic pigment include naphthol red and phthalocyanine blue. Examples of the inorganic pigment include carbon black, titanium white (titanium oxide), yellow iron oxide, and red iron oxide.

When the composition (I) contains the coloring pigment, the content ratio of the coloring pigment is preferably 0.01% by mass or more, more preferably 0.1% by mass or more, and still more preferably 0.5% by mass or more, and is preferably 40% by mass or less, more preferably 30% by mass or less, and still more preferably 20% by mass or less, for example, 0.01 to 40% by mass, based on 100% by mass of the solid content of the composition (I).

As the dispersant, a material capable of improving the dispersibility of an insoluble component (for example, a pigment) in water in the coating composition is preferable. By using the dispersant, for example, a coating film having a good appearance can be easily formed, and a coating film having excellent crack resistance can be easily formed. Examples of the dispersant include polymers having a pigment adsorptive group (pigment affinity group), and having a compatible chain such as fatty acid, polyamino, polyether, polyester, polyurethane, and poly (meth)acrylate. Examples of the pigment adsorptive group include carboxy groups, acid anhydride groups, phosphoric acid groups, amino groups, salt groups thereof, and ammonium salt groups.

When the composition (I) contains the dispersant, the content ratio of the dispersant is preferably 0.1% by mass or more and more preferably 0.2% by mass or more, and is preferably 5% by mass or less and more preferably 3% by mass or less, for example, 0.1 to 5% by mass, based on 100% by mass of the solid content of the composition (I).

The defoamer is preferably a material capable of suppressing generation of bubbles during the production and application of the coating composition or a material capable of breaking bubbles generated in the coating composition. By using the defoamer, generation of air bubble marks or pinholes in the coating film can be suppressed, for example, and thus the film formability and crack resistance of the coating film can be further improved. Examples of the defoamer include silicone-based defoamers, polymer-based (non-silicone-based) defoamers, and mineral oil-based defoamers.

When the composition (I) contains the defoamer, the content ratio of the defoamer is preferably 0.05% by mass or more and more preferably 0.1% by mass or more, and is preferably 5% by mass or less and more preferably 3% by mass or less, for example, 0.05 to 5% by mass, based on 100% by mass of the solid content of the composition (I).

As the viscosity adjusting agent, a material capable of suppressing sedimentation of an insoluble component (for example, a pigment) in water in the coating composition and capable of improving the storage stability of the coating composition is preferable. Examples of the viscosity adjusting agent include organic thixotropic agents such as hydrogenated castor oil-based thixotropic agents, amide wax-based thixotropic agents, polyethylene oxide-based thixotropic agents, and urethane-based thixotropic agents; and inorganic thixotropic agents such as clay minerals (for example, bentonite, smectite, and hectorite) and synthetic fine silica.

When the composition (I) contains the viscosity adjusting agent, the content ratio of the viscosity adjusting agent is preferably 0.01% by mass or more and more preferably 0.05% by mass or more, and is preferably 5% by mass or less and more preferably 3% by mass or less, for example, 0.01 to 5% by mass, based on 100% by mass of the solid content of the composition (I).

Examples of the coalescent include alcohols, glycol ethers, and esters. Examples of the alcohols include isopropyl alcohol and 2,2,4-trimethylpentanediol. Examples of the glycol ethers include ethylene glycol monobutyl ether, ethylene glycol diethyl ether, diethylene glycol monobutyl ether, diethylene glycol diethyl ether, propylene glycol diethyl ether, dipropylene glycol diethyl ether, dipropylene glycol methyl ether, and dipropylene glycol n-butyl ether. Examples of the esters include 2,2,4-trimethyl-1,3-pentanediol monoisobutyrate.

When the composition (I) contains the coalescent, the content ratio of the coalescent is preferably 0.1% by mass or more and more preferably 0.5% by mass or more, and is preferably 15% by mass or less and more preferably 5% by mass or less, for example, 0.1 to 15% by mass, based on 100% by mass of the total amount of the composition (I).

### <Method for Producing Waterborne Antifouling Coating Composition>

The composition (I) can be produced, for example, by mixing the synthetic resin (A), the rosin-based compound (B), and the water (C). At this time, the usage ratio (A):(B) of the synthetic resin (A) to the rosin-based compound (B) is, for example, 1.0:0.3 to 1.0:4.0, preferably 1.0:0.7 to 1.0:3.0, more preferably 1.0:0.9 to 1.0:2.8, still more preferably 1.0:1.2 to 1.0:2.5, further preferably 1.0:1.4 to 1.0:2.4, and particularly preferably 1.0:1.5 to 1.0:2.3 on a mass basis.

The composition (I) can be produced, for example, by placing the synthetic resin (A), the rosin-based compound (B), the water (C), if necessary, the antifouling agent (D), and if necessary, the above other components in a stirring container at once or in any order, mixing each component using known stirring and mixing means, and dispersing or dissolving the components in water (C).

In the production of the composition (I), it is preferable to use the waterborne dispersion of the synthetic resin (A) and the waterborne dispersion of the rosin-based compound (B), and it is more preferable to use the waterborne emulsion of the synthetic resin (A) and the waterborne emulsion of the rosin-based compound (B), from the viewpoint of workability in the production of a coating material and the like. Details of each waterborne dispersion are as described above.

Examples of the stirring and mixing means include means using a paint shaker, a high speed disperser, a sand grinding mill, a basket mill, a ball mill, a three-roll mill, a loss mixer, or a planetary mixer. The mixing (kneading) may be performed while heating or cooling according to the season, the environment, and the like.

Since the composition (I) is a waterborne coating composition, adverse effects on the environment or the human body are extremely small. The composition (I) has excellent storage stability. In one embodiment, the composition (I) can form an antifouling coating film excellent in crack resistance in an outdoor exposure test. Since the antifouling coating film is also provided, for example, on the outboard portion of a ship, it is an advantageous effect that the antifouling coating film is excellent in crack resistance in an outdoor exposure test. In one embodiment, the composition (I) can form an antifouling coating film excellent in antifouling properties, which can suppress adhesion of aquatic organisms over a long period of time.

The content of the volatile organic compound (VOC) such as an organic solvent in the composition (I) is preferably 150 g/L or less and more preferably 100 g/L or less, from the viewpoint of consideration for the natural environment and the coating work environment, and the like. The VOC content in the composition (I) is preferably as low as possible, but the content may be, for example, 1 g/L or more, 5 g/L or more, 10 g/L or more, 20 g/L or more, or 30 g/L or more. The VOC content in the composition (I) may be, for example, 1 to 150 g/L.

The VOC content in the composition (I) is calculated based on the following Formula (1) using the values of the composition specific gravity, the solid content concentration, and the moisture concentration described below, respectively.

$$VOC content ( g / L ) = Composition specific gravity \times 1000 \times ( 100 - solid content concentration - moisture concentration ) / 100 \qquad ( 1 )$$

The composition specific gravity (g/mL) is a value calculated by filling a specific gravity cup having an internal volume of 100 mL with the composition under a temperature condition of 23° C. and measuring the mass of the composition.

The solid content concentration (% by mass) is a value calculated by a method described in the Example section. The solid content of the composition means a heating residue when the composition is dried in a thermostatic chamber at 108° C. for 3 hours, as described in Example section to be described later.

The moisture concentration (% by mass) is the amount (% by mass) of water contained in 100% by mass of the composition, and is measured using a moisture measuring apparatus (for example, CA-310, manufactured by Nittoseiko Analytech Co., Ltd.) according to the Karl Fischer method.

In one embodiment, the composition (I) is preferably a one-component type composition containing the synthetic resin (A), the rosin-based compound (B), and the water (C). In such a one-component type composition, the composition (I) is excellent in storage stability.

### [Application of Waterborne Antifouling Coating Composition]

The antifouling coating film (hereinafter also referred to as an “antifouling coating film (J)”) of the present disclosure is formed from the composition (I). A substrate with an antifouling coating film (hereinafter also referred to as an “antifouling substrate (K)”) of the present disclosure includes a substrate and an antifouling coating film (J) provided on a surface of the substrate.

A method for producing the antifouling substrate (K), includes: a step (1) of obtaining a coated body or an impregnated body by coating or impregnating the substrate (material to be coated) with the composition (I); and a step (2) of drying the coated body or the impregnated body.

Examples of the method for applying the composition (I) include known methods such as air spray coating, airless spray coating, brush coating, and roller coating. Drying of the composition (I) after coating or impregnating may be performed by natural drying or by heat drying. Specifically, the composition (I) after coating or impregnating is dried, for example, by leaving the composition (I) to stand at a temperature of −5 to 40° C. for preferably about 1 to 10 days, more preferably about 1 to 8 days, whereby an antifouling coating film (J) can be obtained.

Alternatively, the antifouling substrate (K) can also be produced by forming the antifouling coating film (J) from the composition (I) on a surface of a temporary substrate, peeling the antifouling coating film (J) from the temporary substrate, and attaching the antifouling coating film (J) to the substrate to be antifouling. At this time, the antifouling coating film (J) may be attached onto the substrate via an adhesive layer.

The surface of the substrate may be primer-treated, and the substrate may have a layer formed from various resin-based coating materials such as an epoxy resin-based coating material, a vinyl resin-based coating material, a (meth)acrylic resin-based coating material, and a urethane resin-based coating material, on the surface thereof. In this case, the surface of the substrate on which the antifouling coating film (J) is provided means a surface after the primer treatment or a surface of a layer formed from the above resin-based coating material.

The substrate is not particularly limited. The composition (I) is preferably used, for example, for antifouling a substrate over a long period of time in a wide range of industrial fields such as ships. Therefore, examples of the substrate include a hull outer plate (steel plate or the like) of a ship, an underwater structure, a water supply/discharge pipe of sea water or fresh water in various facilities, a fishing material, and other marine materials. Examples of the ship include a large steel ship such as a container ship or a tanker, a fishing boat, an FRP ship, a wooden ship, a yacht, a motor boat, and a personal watercraft. Examples of the hull outer plate include a ship bottom outer plate and an outboard portion. Examples of the underwater structure include oil pipelines, water conduit pipes, circulating water pipes, water supply/drain ports in various facilities, submarine cables, sea water utilization equipment (for example, sea water pumps), and various underwater civil engineering structures in megafloats, coastal roads, undersea tunnels, port facilities, offshore wind power generation facilities, canals and water channels, and the like. Examples of the above facilities include a factory, a thermal power plant, and a nuclear power plant. Examples of the fishing material include ropes, fishing gears, fishing nets, floats, and buoys. Examples of other marine materials include swimsuits, diver suits, underwater glasses, oxygen cylinders, and torpedoes. Among these, the hull outer plate of the ship, the underwater structure, the fishing material, and the water supply/discharge pipe are preferable, the hull outer plate and the underwater structure of the ship are more preferable, and the hull outer plate of the ship is particularly preferable.

When the antifouling substrate (K) is produced, the composition (I) may be directly applied to the surface of the substrate in a case where the substrate is the fishing net or the steel plate, the surface of the substrate may be impregnated with the composition (I) in a case where the substrate is the fishing net, and the composition (I) may be applied to the surface of an underlaying layer after the underlaying layer is formed by previously applying an underlaying material such as a rust inhibitor or a primer to the surface of the substrate in a case where the substrate is the steel plate. In addition, the antifouling coating film (J) may be further formed for the purpose of repair on the surface of the antifouling substrate with the antifouling coating film (J) or the conventional antifouling coating film formed on the substrate as in the antifouling substrate including a deteriorated antifouling coating film on the substrate.

The thickness of the antifouling coating film (J) is not particularly limited, and is, for example, about 30 to 1,000 μm. When the antifouling coating film (J) is formed, examples of the method include a method in which the composition (I) is applied one or more times such that a thickness of the antifouling coating film formed by one coating is preferably 10 to 300 μm and more preferably 30 to 200 μm.

The ship including the antifouling coating film (J) can suppress a decrease in a ship speed and an increase in fuel consumption due to the ability to suppress the adhesion of the aquatic organisms. The underwater structure including the antifouling coating film (J) can maintain the function of the underwater structure over a long period of time due to the ability to suppress the adhesion of the aquatic organisms over a long period of time. The fishing net including the antifouling coating film (J) has a low risk of environmental pollution and can suppress clogging of the mesh due to the ability to suppress the adhesion of the aquatic organisms. The water supply/discharge pipe including the antifouling coating film (J) on the inner surface thereof can suppress clogging of the water supply/discharge pipe and a decrease in flow rate due to the ability to suppress the adhesion and propagation of the aquatic organisms.

### EMBODIMENTS

The present disclosure relates to, for example, the following [1] to [19].

[1] A waterborne antifouling coating composition containing a synthetic resin (A), a rosin-based compound (B) having a weight average molecular weight of 800 or more, and water (C).

[2] The waterborne antifouling coating composition according to above [1], in which a content ratio (A):(B) of the synthetic resin (A) to the rosin-based compound (B) in the composition is 1.0:0.3 to 1.0:4.0 on a mass basis.

[3] The waterborne antifouling coating composition according to above [1] or [2], in which a content ratio (A):(B) of the synthetic resin (A) to the rosin-based compound (B) in the composition is 1.0:0.7 to 1.0:3.0 on a mass basis.

[4] The waterborne antifouling coating composition according to any one of above [1] to [3], in which the rosin-based compound (B) has an acid value of 100 mgKOH/g or less.

[5] The waterborne antifouling coating composition according to any one of above [1] to [4], in which the rosin-based compound (B) contains a rosin-based ester.

[6] The waterborne antifouling coating composition according to above [5], in which the rosin-based ester is an ester of rosin or a derivative thereof and a trihydric or higher polyhydric alcohol.

[7] The waterborne antifouling coating composition according to any one of above [1] to [6], in which the synthetic resin (A) is at least one selected from a (meth)acrylic resin, a styrene-based resin, and a urethane-based resin.

[8] The waterborne antifouling coating composition according to any one of above [1] to [7], in which a content ratio of the water (C) in the composition is 20 to 60% by mass.

[9] The waterborne antifouling coating composition according to any one of above [1] to [8], in which the rosin-based compound (B) has a glass transition temperature (Tg) of 0 to 50° C.

[10] An antifouling coating film formed from the waterborne antifouling coating composition according to any one of above [1] to [9].

[11] A substrate with an antifouling coating film including: a substrate; and the antifouling coating film according to above [10] provided on a surface of the substrate.

[12] A method for producing a substrate with an antifouling coating film, the method including: a step (1) of obtaining a coated body or an impregnated body by coating or impregnating a substrate with the waterborne antifouling coating composition according to any one of above [1] to [9]; and a step (2) of drying the coated body or the impregnated body.

[13] A method for producing a waterborne antifouling coating composition, the method including: a step of mixing a synthetic resin (A), a rosin-based compound (B) having a weight average molecular weight of 800 or more, and water (C).

[14] The method for producing a waterborne antifouling coating composition according to above [13], in which, in the step, a usage ratio (A):(B) of the synthetic resin (A) to the rosin-based compound (B) is 1.0:0.3 to 1.0:4.0 on a mass basis.

[15] The method for producing a waterborne antifouling coating composition according to above or [14], in which, in the step, a usage ratio (A):(B) of the synthetic resin (A) to the rosin-based compound (B) is 1.0:0.7 to 1.0:3.0 on a mass basis.

[16] The method for producing a waterborne antifouling coating composition according to any one of [13] to [15], in which the rosin-based compound (B) contains a rosin-based ester.

[17] The method for producing a waterborne antifouling coating composition according to any one of above [13] to [16], in which, in the step, a waterborne dispersion of the synthetic resin (A) and a waterborne dispersion of the rosin-based compound (B) are used.

[18] The method for producing a waterborne antifouling coating composition according to any one of above [13] to [17], in which, in the step, a waterborne dispersion of the synthetic resin (A) is used, and the waterborne dispersion of the synthetic resin (A) has a pH of 7.0 to 9.0 at 23° C.

[19] The method for producing a waterborne antifouling coating composition according to any one of above [13] to [18], in which the rosin-based compound (B) has a glass transition temperature (Tg) of 0 to 50° C.

### EXAMPLES

Hereinafter, the waterborne antifouling coating composition of the present disclosure will be described more specifically based on Examples, but the waterborne antifouling coating composition of the present disclosure is not limited to the following Examples at all. In the following Examples and Comparative Examples, “part(s)” represents “part(s) by mass”.

### [Solid Content Concentration]

The solid content of the composition and each component means a heating residue when the composition and each component are respectively dried in a thermostatic chamber at 108° C. for 3 hours. Specifically, the heating residue is a residue of a sample obtained by weighing 1.0 g of the sample of the composition or each component in a flat bottom dish, uniformly spreading the sample using a wire having a known mass, and drying the sample in the thermostatic chamber under the conditions of 1 atm and 108° C. for 3 hours. From the amount of the heating residue, solid content concentration (% by mass) of the composition and each component were calculated.

### [Weight Average Molecular Weight (Mw)]

The weight average molecular weight (Mw) of the rosin-based compound (B) was measured under the following measurement conditions using a gel permeation chromatography method (GPC method).

### Measurement Conditions:

Apparatus: “Alliance 2695” (manufactured by Waters Corporation).
Column: one “TSKgel SuperH4000” and two “TSKgel SuperH2000” are connected (all manufactured by Tosoh Corporation, inner diameter 6 mm×length 15 cm)
Eluent: tetrahydrofuran 99% (containing BHT)
Flow rate: 0.6 ml/min
Detector: “RI-104” (manufactured by Shodex)
Column thermostat temperature: 40° C.
Standard substance: standard polystyrene
Sample preparation method: the sample was weighed in a sample tube, and tetrahydrofuran was added to dilute about 100 times.

### [Glass Transition Temperature (Tg)]

The glass transition temperature (Tg) of the rosin-based compound (B) was measured under the following measurement conditions using a differential scanning calorimetry (DSC) apparatus.

### Measurement Conditions:

Apparatus: “DSC Q2000” (manufactured by TA Instruments)
Container: made of aluminum
Temperature rising rate: 20° C./min
Heating range: −50° C. to 150° C.
Temperature modulation: none
Tg measured value: temperature at onset value during second cycle heating
Sample preparation method: the sample was spread thinly on a glass dish, and dried under reduced pressure at 40° C. for 1.5 hours, and crushed in a mortar to obtain about 3 mg of powder.

### [Raw Materials]

### <Waterborne Dispersion of Synthetic Resin (A)>

### PRIMAL TX-100

manufactured by Dow Chemical Company
Waterborne emulsion of a (meth)acrylic resin (self-crosslinking type), Solid content concentration: 46.5% by mass, pH: 7.8, Tg: 28° C.

### <Waterborne Dispersion of Rosin-Based Compound (B)>

### HARIESTER SK-218NS

manufactured by Harima Chemicals Group, Inc.
Waterborne emulsion of rosin-based ester (ester of rosin or derivative thereof and trihydric or higher polyhydric alcohol), solid content concentration: 50% by mass, pH: 8.2, Acid value (solid content): 13.6 mgKOH/g, Mw: 1,200, Tg: 35° C.

### Aquadhes 6203

manufactured by PinoPine
Waterborne dispersion of rosin-based ester (ester of rosin or derivative thereof and trihydric or higher polyhydric alcohol), solid content concentration: 59% by mass, pH: 6.4, Acid value (solid content): 43.7 mgKOH/g, Mw: 1,000, Tg: 27° C.
   <Waterborne Dispersion or Aqueous Solution of Rosin-Based Compound (cB) Other than Compound (B) Above>

### HARSIZE NES-500

manufactured by Harima Chemicals Group, Inc.
Waterborne emulsion of rosin, solid content concentration: 50% by mass, pH: 5.7, Acid value (solid content): 246 mgKOH/g, Mw: 310, Tg: 61° C.

### Bremar SP3180 35% Wasser/NH3

manufactured by Robert Kraemer GmbH & Co. KG,
rosin aqueous solution, solid content concentration: 35% by mass, pH: 8.8, Acid value (solid content): 251.0 mgKOH/g, Mw: 460, Tg: 90° C.

### Bremar SP3180 50% Wasser/NaOH

manufactured by Robert Kraemer GmbH & Co. KG,
Rosin aqueous solution, solid content concentration: 50% by mass, pH: 9.2, Acid value (solid content): 6.2 mgKOH/g, Mw: 290, Tg: 43° C.

### <Extender Pigment>

### Talc FC-1

Talc manufactured by Fukuoka Talc Co., LTD.

### Mica Powder 325 Mesh

Mica manufactured by Fukuoka Talc Co., LTD.

### <Coloring Pigment>

### Novoperm Red F5RK

Naphthol Red manufactured by Clariant Japan KK

### Mitsubishi Carbon Black

Carbon black manufactured by Mitsubishi Chemical Corporation

### <Antifouling Agent (D)>

### Lo Lo Tint 97

manufactured by American Chemet Corporation, cuprous oxide

### Selektope

Medetomidine manufactured by I-Tech AB

### <Dispersant>

### DISPERBYK-190

manufactured by BYK Japan KK,
Solution of high molecular weight block polymer having pigment affinity group, solid content concentration: 40% by mass

### <Defoamer>

### BYK-018

manufactured by BYK Japan KK,
Mixture of foam-breaking polysiloxane and hydrophobic particles, solid content concentration: 97% by mass

### <Viscosity Adjusting Agent>

### Adekanol UH-752

manufactured by ADEKA Corporation,
Polyether polyol-based urethane polymer, solid content concentration: 28% by mass

### Bentone DE

manufactured by Elementis Specialties Inc.
Hectorite clay

### <Coalescent>

### KYOWANOL M

manufactured by KH Neochem Co., Ltd.,
2,2,4-Trimethyl-1,3-pentanediol monoisobutyrate

### Dawanol DPM Glycol Ether

manufactured by Dow Chemical Company
Dipropylene glycol methyl ether.

### Dawanol DPnB Glycol Ether

manufactured by Dow Chemical Company
Dipropylene glycol n-butyl ether

### [Preparation of Antifouling Coating Composition]

### Example 1

The antifouling coating composition was prepared as follows.

To a container, 11.8 parts of ion-exchanged water, 1.5 parts of DISPERBYK-190 (dispersant), and 0.2 parts of Bentone DE (viscosity adjusting agent) were added and mixed using a paint shaker until each component was uniformly dispersed or dissolved in water. Thereafter, 3.0 parts of Mica Powder 325 mesh (extender pigment), 37.0 parts of Lo Lo Tint 97 (antifouling agent (D)), 0.6 parts of Novoperm Red F5RK (coloring pigment), 0.3 parts of BYK-018 (defoamer), and 100 parts of glass beads were added to the above container, and stirred for 1 hour using a paint shaker to disperse these components to obtain a mixture.

After the dispersion, 11.7 parts of PRIMAL TX-100 (waterborne dispersion of synthetic resin (A)), 24.8 parts of HARIESTER SK-218NS (waterborne dispersion of rosin-based compound (B)), 6.5 parts of Talc FC-1 (extender pigment), 0.2 parts of Adekanol UH-752 (viscosity adjusting agent), and 2.4 parts of KYOWANOL M (coalescent) were added to the filtrate obtained by removing the glass beads from the above mixture with a filtration net (mesh opening: 80 mesh) while rotating the disperser, and the resulting mixture was dispersed for 20 minutes to obtain an antifouling coating composition.

### Examples 2 to 8 and Comparative Examples 1 to 3

The antifouling coating composition was prepared in the same manner as in Example 1 except that a type and a blending amount of each component were changed as shown in Table 1 or 2.

### [Evaluation of Physical Properties of Antifouling Coating Composition]

### <Storage Stability Test>

The state (initial state of coating material) of the antifouling coating compositions of Examples or Comparative Examples one day after the preparation was evaluated according to the following criteria. In addition, the state of the above antifouling coating composition of Examples and Comparative Examples after the antifouling coating composition was placed in a sealed container and stored at 50° C. for 1 month was evaluated according to the following criteria.

### Evaluation Criteria

AA: The composition can be uniformly mixed by hand stirring, and there are no seedings or lumps.

BB: Gelation or sedimentation is severe, or there are seedings or lumps.

### <Outdoor Exposure Test>

The antifouling coating composition of Examples or Comparative Examples was applied onto a test plate coated with the anticorrosive coating material using an applicator (space 0.5 mm) to prepare a test plate. The test plate was dried at 23° C. for 1 week and installed on an exposed stand in accordance with JIS K 5600-7-6 (outdoor exposure weather resistance), and after 6 months, the state of generation of cracks in the coating film was evaluated in accordance with the following criteria. The above test was performed on five test plates in each of Examples and Comparative Examples, and the number of test plates in which cracks were generated was confirmed.

### Evaluation Criteria

AA: Cracks cannot be recognized even when magnified 100 times using an optical microscope (High Speed Microscope VW-9000 (manufactured by KEYENCE Corporation), lens: VW-600C).

BB: Cracks can be recognized visually or when magnified 100 times using the above optical microscope.

### <Static Antifouling Properties Test>

An epoxy-based anticorrosive coating material (product name “BANNOH 500”, manufactured by Chugoku Marine Paints, Ltd.) was applied to the sandblasted steel plate (300 mm×100 mm×2.3 mm) using an applicator such that the dry film thickness was 150 μm, and dried to form a cured coating film. Next, an epoxy-based binder coating material (product name “BANNOH 500N”, manufactured by Chugoku Marine Paints, Ltd.) was applied to the cured coating film such that the dry film thickness was 100 μm, and dried at 23° C. for 1 day to prepare a test plate.

Next, the antifouling coating composition of Examples or Comparative Examples was applied to the above test plate (the surface of the cured coating film of the above epoxy-based binder coating material) using an applicator such that the dry film thickness was 150 μm, and dried at 23° C. for 7 days to form an antifouling coating film, thereby preparing a test plate with an antifouling coating film.

The test plate with an antifouling coating film was suspended and immersed at a position of about 2 m below the sea water surface off the coast of Hatsukaichi, Hiroshima Prefecture to be in a stationary state. Twelve months after the start of immersion, the area of marine organisms that adhered to the antifouling coating film was measured in a case where the total area (test surface) of the antifouling coating film on the test plate that was constantly submerged in seawater is taken as 100%, and the static antifouling properties were evaluated based on the following evaluation criteria.

### Evaluation Criteria

5: The area to which marine organisms adhered is less than 1% of the test surface.

4: The area is 18 or more and less than 10% of the test surface.

3: The area is 10% or more and less than 30% of the test surface.

2: The area is 30% or more and less than 70% of the test surface.

1: The area is 70 or more of the test surface.

TABLE 1

| | | Example | Example | Comparative | Comparative | Comparative |
|---|---|---|---|---|---|---|
| | | 1 | 2 | Example 1 | Example 2 | Example 3 |
| Waterborne dispersion of | PRIMAL TX-100 | 11.7 | 11.7 | 11.7 | 9.8 | 11.5 |
| synthetic resin (A) | | | | | | |
| waterborne dispersion of | HARIESTER SR-218NS | 24.8 | | | | |
| rosin-based compound (B) | Aquaches 6203 | | 21.9 | | | |
| Waterborne dispersion of | HARSIZE NES-500 | | | 24.8 | | |
| aqueous solution of rosin- | Bremar SP3180 35% Wasser/NH3 | | | | 29.3 | |
| based compound (cB) | Bremar SP3180 50% Wasser/NaOH | | | | | 24.2 |
| water (C) | Ion-exchanged water | 11.8 | 14.7 | 11.8 | 11.3 | 12.6 |
| Extender pigment | Talc FC-1 | 6.5 | 6.5 | 6.5 | 6.2 | 6.5 |
| | Mica Powder 325mesh | 3.0 | 3.0 | 3.0 | 2.9 | 3.0 |
| Coloring pigment | Novoperm Red F5RK | 0.6 | 0.6 | 0.6 | 0.6 | 0.6 |
| Antifouling agent (D) | Lo Lo Tint 97 | 37.0 | 37.0 | 37.0 | 35.4 | 37.0 |
| Dispersant | DISPERBYK-190 | 1.5 | 1.5 | 1.5 | 1.5 | 1.5 |
| Defoamer | BYK-018 | 0.3 | 0.3 | 0.3 | 0.3 | 0.3 |
| Viscosity adjusting agent | Adekanol CH-752 | 0.2 | 0.2 | 0.2 | 0.2 | 0.2 |
| | Bentone DE | 0.2 | 0.2 | 0.2 | 0.2 | 0.2 |
| Coalescent | KYOWANOL M | 2.4 | 2.4 | 2.4 | 2.3 | 2.4 |
| | [Total] | 100.0 | 100.0 | 100.0 | 100.0 | 100.0 |
| Rosin-based compound (B), (cB) | Content ratio (% by mass) | 12.4 | 12.3 | 12.4 | 10.3 | 12.1 |
| Synthetic resin (A) | Content ratio (% by mass) | 5.4 | 5.4 | 5.4 | 4.6 | 5.3 |
| Synthetic resin (A): rosin- | Content ratio (on mass basis) | 1:2.3 | 1:2.3 | 1:2.3 | 1:2.3 | 1:2.3 |
| based compound (B), (cB) | | | | | | |
| Evaluation | | | | | | |
| Storage stability test | Initial state of costing | AA | AA | AA | BB | BB |
| | material | | | | | |
| | State of coating material | AA | AA | BB | — | — |
| | after storing at 50° C. for 1 | | | | | |
| | month. | | | | | |
| Static antifouling properties | After twelve months of | 5 | 5 | 5 | — | — |
| test | immersion | | | | | |
| Outdoor exposure test | Number of test plates in which | 0/5 | 0/5 | 3/5 | — | — |
| | cracks are generated/number of | | | | | |
| | test plates | | | | | |

TABLE 2

| | | Example | Example | Example | Example | Example | Example |
|---|---|---|---|---|---|---|---|
| | | 3 | 4 | 5 | 6 | 7 | 8 |
| Waterborne dispersion of | PRIMAL TX-100 | 27.2 | 20.4 | 16.3 | 13.6 | 11.7 | 10.0 |
| synthetic resin (A) | | | | | | | |
| Waterborne dispersion of | HARIESTER SK-218NS | 12.6 | 19.0 | 22.3 | 25.3 | 27.2 | 28.5 |
| rosin-based compound (B) | | | | | | | |
| Water (C) | Ion-exchanged water | 9.2 | 9.6 | 9.9 | 10.1 | 10.1 | 10.5 |
| Extender pigment | Talc FC-1 | 6.0 | 6.0 | 6.0 | 6.0 | 6.0 | 6.0 |
| | Mica Powder 325mesh | 3.0 | 3.0 | 3.0 | 3.0 | 3.0 | 3.0 |
| Coloring pigment | Mitsubishi Carbon Black | 2.0 | 2.0 | 2.0 | 2.0 | 2.0 | 2.0 |
| Antifouling agent (D) | Lo Lo Tint. 97 | 33.0 | 33.0 | 33.0 | 33.0 | 33.0 | 33.0 |
| | Selektope | 0.1 | 0.1 | 0.1 | 0.1 | 0.1 | 0.1 |
| Dispersant | DISBERBYR-190 | 3.0 | 3.0 | 3.0 | 3.0 | 3.0 | 3.0 |
| Defoamer | BYK-018 | 0.3 | 0.3 | 0.3 | 0.3 | 0.3 | 0.3 |
| Viscosity adjusting agent | Adekanol UR-752 | 0.2 | 0.2 | 0.2 | 0.2 | 0.2 | 0.2 |
| | Bentone DE | 0.2 | 0.2 | 0.2 | 0.2 | 0.2 | 0.2 |
| Coalescent | Dawanol DPM Glycol Ether | 1.2 | 1.2 | 1.2 | 1.2 | 1.2 | 1.2 |
| | Dawanol DEnB Glycol Ether | 2.0 | 2.0 | 2.0 | 2.0 | 2.0 | 2.0 |
| | Total | 100.0 | 100.0 | 100.0 | 100.0 | 100.0 | 100.0 |
| Rosin-based compound (B) | Content ratio (% by mass) | 6.3 | 9.5 | 11.4 | 12.7 | 13.6 | 14.3 |
| Synthetic resin (A) | Content ratio (s by mass) | 12.6 | 9.5 | 7.6 | 6.3 | 5.4 | 4.7 |
| Synthetic resin (A): rosin- | Content ratio (on mass basis) | 1:0.5 | 1:1 | 1:1.5 | 1:2 | 1:2.5 | 1:3.1 |
| based compound (B) | | | | | | | |
| Evaluation | | | | | | | |
| Storage stability test | Initial state of coating | AA | AA | AA | AA | AA | AA |
| | material | | | | | | |
| | State of coating material after | AA | AA | AA | AA | AA | AA |
| | storing at 50° C. for 1 month | | | | | | |
| Static antifouling | After twelve months of | 3 | 4 | 5 | 5 | 5 | 5 |
| properties test | immersion | | | | | | |
| Outdoor exposure test | Number of test plates in which | 0/5 | 0/5 | 0/5 | 0/5 | 1/5 | 3/5 |
| | cracks are generated/number of | | | | | | |
| | tast plates | | | | | | |

What is claimed is:

1. A waterborne antifouling coating composition comprising:
a synthetic resin (A),
a rosin-based compound (B) having a weight average molecular weight of 800 or more, and
water (C).

2. The waterborne antifouling coating composition according to claim 1, wherein a content ratio (A):(B) of the synthetic resin (A) to the rosin-based compound (B) in the composition is 1.0:0.7 to 1.0:3.0 on a mass basis.

3. The waterborne antifouling coating composition according to claim 1, wherein the rosin-based compound (B) has an acid value of 100 mgKOH/g or less.

4. The waterborne antifouling coating composition according to claim 1, wherein the rosin-based compound (B) comprises a rosin-based ester.

5. The waterborne antifouling coating composition according to claim 4, wherein the rosin-based ester is an ester of rosin or a derivative thereof and a trihydric or higher polyhydric alcohol.

6. The waterborne antifouling coating composition according to claim 1, wherein the synthetic resin (A) is at least one selected from a (meth)acrylic resin, a styrene-based resin, and a urethane-based resin.

7. The waterborne antifouling coating composition according to claim 1, wherein a content ratio of the water (C) in the composition is 20 to 60% by mass.

8. The waterborne antifouling coating composition according to claim 1, wherein the rosin-based compound (B) has a glass transition temperature (Tg) of 0 to 50° C.

9. An antifouling coating film formed from the waterborne antifouling coating composition according to claim 1.

10. A substrate with an antifouling coating film comprising:
a substrate; and
the antifouling coating film according to claim 9 provided on a surface of the substrate.

11. A method for producing a substrate with an antifouling coating film, the method comprising:
a step (1) of obtaining a coated body or an impregnated body by coating or impregnating a substrate with the waterborne antifouling coating composition according to claim 1; and
a step (2) of drying the coated body or the impregnated body.

12. A method for producing a waterborne antifouling coating composition, the method comprising: a step of mixing a synthetic resin (A), a rosin-based compound (B) having a weight average molecular weight of 800 or more, and water (C).

13. The method for producing a waterborne antifouling coating composition according to claim 12, wherein in the step, a usage ratio (A):(B) of the synthetic resin (A) to the rosin-based compound (B) is 1.0:0.7 to 1.0:3.0 on a mass basis.

14. The method for producing a waterborne antifouling coating composition according to claim 12, wherein the rosin-based compound (B) comprises a rosin-based ester.

15. The method for producing a waterborne antifouling coating composition according to claim 12, wherein in the step, a waterborne dispersion of the synthetic resin (A) and a waterborne dispersion of the rosin-based compound (B) are used.

16. The method for producing a waterborne antifouling coating composition according to claim 15, wherein the waterborne dispersion of the synthetic resin (A) has a pH of 7.0 to 9.0 at 23° C.

17. The method for producing a waterborne antifouling coating composition according to claim 12, wherein the rosin-based compound (B) has a glass transition temperature (Tg) of 0 to 50° C.
